(19) United States
(12) Patent Application Publication
(10) Pub. No.: US 2017/0167706 A1
(43) Pub. Date: Jun. 15, 2017

(54) DUAL HEAD FLASHLIGHT

(71) Applicant: Richard Yang, Las Vegas, NV (US)

(72) Inventor: Richard Yang, Las Vegas, NV (US)

(21) Appl. No.: 14/964,493

(22) Filed: Dec. 9, 2015

(51) Int. Cl. F21V 23/04; F21L 4/08; H02J 7/00; F21L 4/02

(52) U.S. Cl. CPC F21V 23/0428; F21L 4/027; F21L 4/085; H02J 7/0052; F21Y 2115/10

(57) ABSTRACT

Aspects of the present disclosure may be embodied as a dual headed flashlight. Embodiments of the present disclosure provide a flashlight having a generally elongated shape having first and second opposing ends. At each of the first and seconds end may be disposed an illumination source. Each of the illumination sources may comprise a light source head that is electrically coupled with a switch that is actuated by an outer casing disposed around the elongated shape. Alternatively, each of the light source heads may be individually actuated on a chassis. In an embodiment, the first and second light source heads are removable, modular, and interchangeable.

### CROSS-REFERENCE TO RELATED APPLICATIONS

This application claims priority to U.S. Provisional Application No. 62/185,367, entitled “DUAL HEAD FLASHLIGHT,” filed Jun. 26, 2015, and to U.S. Provisional Application No. 62/089,596, entitled “DUAL-HEAD FLASHLIGHT,” filed Dec. 9, 2014, the entire contents of each of which is specifically incorporated by reference herein.

### BACKGROUND

Field of the Invention

The described embodiments relate generally to illumination devices, and more particularly to a dual head flashlight.

Description of Related Art

Typical flashlights are designed with a battery housing and a single light source, which is generally a small incandescent bulb or a Light Emitting Diode (LED). Previous flashlight designs typically include an external switch device for connecting a circuit between a battery in the battery housing and the light source. In some flashlights, the switch is a manual slider switch. In other flashlights, the switch is an external pushbutton switch.

Some dual light source flashlights exist, but the known dual light source flashlights typically employ a single external switch, similar to known single-head flashlights. The light sources of the dual light source flashlights can be energized by clicking, an external pushbutton switch for example, in a series of clicks. For example, a first click typically energizes a first light source, a second click typically energizes the second light source, a third click energizes both light sources simultaneously, and a fourth click turns both light sources off. Several problems exist with previously known dual light source flashlights. First, the series of clicks required to energize the desired light source may be annoying for a user. If a user misses the desired setting, then the entire cycle must be repeated. Second, the first and second light source in prior dual light source flashlights are fixed, meaning that they cannot be changed or swapped for alternative light source heads.

### SUMMARY

Embodiments of a dual head flashlight are described. In one embodiment, the flashlight includes an elongated chassis. The flashlight may also include a first head having an illumination source, a first switch for energizing the first illumination source, and a first casing disposed around the first illumination source, the first head being slidably coupled to the elongated chassis, and configured to engage the first switch in a first position relative to the elongated chassis and to disengage the first switch in a second position relative to the elongated chassis. Additionally, the flashlight may include a second head having an illumination source, a second switch for energizing the second illumination source, and a second casing disposed around the second illumination source, the second head being slidably coupled to the elongated chassis, and configured to engage the second switch in a first position relative to the elongated chassis and to disengage the second switch in a second position relative to the elongated chassis.

In an embodiment at least one of the first head and the second head are removable from the elongated chassis. In a further embodiment at least one of the first head and the second head are interchangeable with one or more modular heads of an alternative configuration.

In an embodiment, at least one of the first light source and the second light source comprise a Light Emitting Diode (LED) configured to emit light at an InfraRed (IR) wavelength. In another embodiment at least one of the first light source and the second light source comprise a Light Emitting Diode (LED) configured to emit light at an UltraViolet (UV) wavelength. In such an embodiment, the UV wavelength is a wavelength that causes a UV fluorescent tracer fluid to fluoresce.

In an embodiment, the flashlight includes a power source coupled to the chassis and configured to supply power for energizing the first light source and the second light source. The flashlight may further include a charging circuit configured to receive power from an external power supply and to charge the power source. Additionally, the flashlight may include a charging port coupled to the charging circuit, the charging port configured to interface with the external power supply. In a particular embodiment, the charging port comprises a Universal Serial Bus (USB) port.

The flashlight may also include a control circuit configured to control a characteristic of the power supplied by the power source to at least one of the first light source and the second light source. In an embodiment, at least one of the first switch and the second switch is configured to be set to a third position, wherein the third position is configured cause the control circuit to modify the power supplied from the power source to at least one of the first light source and the second light source.

In another embodiment, the flashlight includes an elongated inner chassis comprising a first illumination source, a first switch for energizing the first illumination source, a second illumination source, and a second switch for energizing the second illumination source. The flashlight may also include an elongated outer casing disposed around the elongated inner chassis and configured to slideably engage the elongated inner chassis, where the elongated outer casing is slideable between a first position that activates the first switch and a second position that activates the second switch.

In another embodiment, the flashlight includes an elongated chassis. The flashlight may further include a first head having an illumination source, a first switch for energizing the first illumination source, and a first casing disposed around the first illumination source, the first head being slidably coupled to the elongated chassis, and configured to engage the first switch in a first position relative to the elongated chassis and to disengage the first switch in a second position relative to the elongated chassis. Additionally, the flashlight may include a second head having an illumination source, a second switch for energizing the second illumination source, and a second casing disposed around the second illumination source, the second head being slidably coupled to the elongated chassis, and configured to engage the second switch in a first position relative to the elongated chassis and to disengage the second switch in a second position relative to the elongated chassis. The flashlight may also include a power source coupled to the chassis and configured to supply power for energizing the first light source and the second light source. Further, the flashlight may include a charging circuit configured to receive power from an external power supply and to charge the power source. The flashlight may include a Universal Serial Bus (USB) charging port coupled to the charging circuit, the charging port configured to interface with the external power supply. Additionally, the flashlight may include a control circuit configured to control a characteristic of the power supplied by the power source to at least one of the first light source and the second light source.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 illustrates one embodiment of a dual head flashlight in accordance with embodiments of the present disclosure;

FIG. 2 is a side view diagram illustrating one embodiment of the flashlight in accordance with embodiments of the disclosure;

FIG. 3 is a side view cross-sectional diagram illustrating one embodiment of the flashlight in accordance with embodiments of the disclosure;

FIG. 4 is an exploded view block diagram illustrating one embodiment of the flashlight in accordance with embodiments of the disclosure;

FIG. 5A is a schematic block diagram illustrating one embodiment of an electrical circuit of the flashlight in accordance with embodiments of the disclosure;

FIG. 5B is a schematic block diagram illustrating one embodiment of an electrical circuit of the flashlight in accordance with embodiments of the disclosure;

FIG. 5C is a schematic block diagram illustrating one embodiment of an electrical circuit of the flashlight in accordance with embodiments of the disclosure;

FIG. 6 is a side view cross-sectional diagram illustrating another embodiment of the flashlight in accordance with embodiments of the disclosure;

FIG. 7 is a perspective view diagram illustrating another embodiment of a dual headed flashlight, in accordance with embodiments of the disclosure;

FIG. 8A is a schematic block diagram illustrating a cross-sectional view of one embodiment of the flashlight;

FIG. 8B is a schematic block diagram illustrating a cross-sectional view of one embodiment of the flashlight; and

FIG. 9 is a schematic block diagram illustrating an embodiment of an electrical circuit of one embodiment of the flashlight.

### DETAILED DESCRIPTION

Aspects of the present disclosure may be embodied as a dual headed flashlight. Embodiments of the present disclosure provide a flashlight having a generally elongated shape having first and second opposing ends. At each of the first and seconds end may be disposed an illumination source. Each of the illumination sources may comprise a light source head that is electrically coupled with a switch that is actuated by an outer casing disposed around the elongated shape. Alternatively, each of the light source heads may be individually actuated on a chassis. In an embodiment, the first and second light source heads are removable, modular, and interchangeable.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided to give a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

The description of elements in each figure may refer to elements of proceeding figures. Like numbers refer to like elements in all figures, including alternate embodiments of like elements.

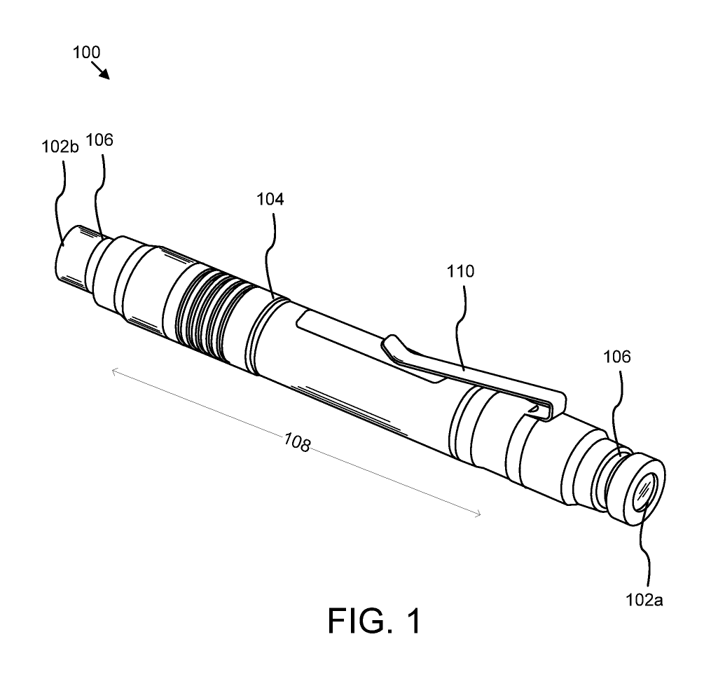

FIG. 1 illustrates one embodiment of a dual head flashlight 100 in accordance with embodiments of the present disclosure. In the depicted embodiment, the dual head flashlight (hereinafter “flashlight”) is formed having a generally elongated shape. The generally elongated shape may be tubular, as depicted. In other words, a cross-sectional profile of the flashlight 100 taken along a lateral axis will resemble a circle. Alternatively, the flashlight 100 may have a cross-sectional profile that resembles other geometric shapes, including, but not limited to, squares, triangles, hexagons, etc.

Illumination sources 102 (referred to collectively as sources 102, and individually as source 102a or source 102b) may be disposed at opposing ends of the flashlight 100. As will be disclosed in greater detail below, the flashlight 100 is configured to activate, in one embodiment, one of the illumination sources 102 at a time. This may be accomplished by sliding an outer casing 104 towards the illumination source 102a, 102b that is desired to be activated. The outer casing 104 may move, with reference to an inner chassis 106, between any of at least three positions. These at least three positions may include a first position that activates the illumination source 102a, a second position that activates the illumination source 102b, and a third position that de-activates both illumination sources 102. In one embodiment, the outer casing 104 slides, relative to the inner chassis 106, in longitudinal directions indicated by arrow 108.

In one embodiment, the illumination sources 102 may include any apparatus for producing illumination from an electric current. Examples include, but are not limited to, fluorescent lamps, light emitting diodes, incandescent lamps, halogen lamps, infrared lamps, etc. As will be recognized by one of skill in the art, any other light emitting device may be implemented as an illumination source for the flashlight 100.

In certain embodiments, the flashlight 100 may be formed or constructed of various types of materials. In one example, the flashlight 100 may be constructed primarily of metal alloys, or any other hardened, rigid material. Different surface textures may be applied to or formed on the surface of the flashlight 100. For example, in the depicted embodiment the flashlight 100 includes different areas of surface treatments including, but not limited to, cylindrical knurling, bevels, rings, grooves, etc. In other embodiments, accessories may be attached to the flashlight 100 such as a pocket clip 110.

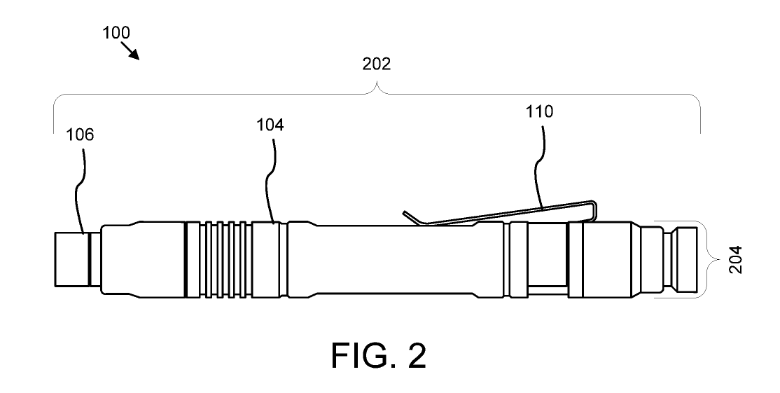

FIG. 2 is a side view diagram illustrating one embodiment of the flashlight 100 in accordance with embodiments of the disclosure. The flashlight 100, as depicted, may be formed with dimensions suitable for use as a pocket penlight. For example, the flashlight 100 may have a length 202 in the range of between about 3 and 10 inches.

The flashlight 100 may have a diameter 204 selected according to a size of battery that is used to energize the illumination sources. In the example of a penlight, 2 AA-sized batteries may be used, and the internal chassis 106 may be sized to receive 2 AA-sized batteries. The overall diameter 204 of the outer casing 104, therefore, is sized to accommodate the batteries and the inner chassis. However, any suitable size and shape of battery may be used and the size of the flashlight 100 may be adjusted accordingly. As used herein, reference to the term “battery” may refer to a single or multiple batteries, and include different types of batteries. Examples of different types of batteries include, but are not limited to, single-use batteries, or rechargeable batteries.

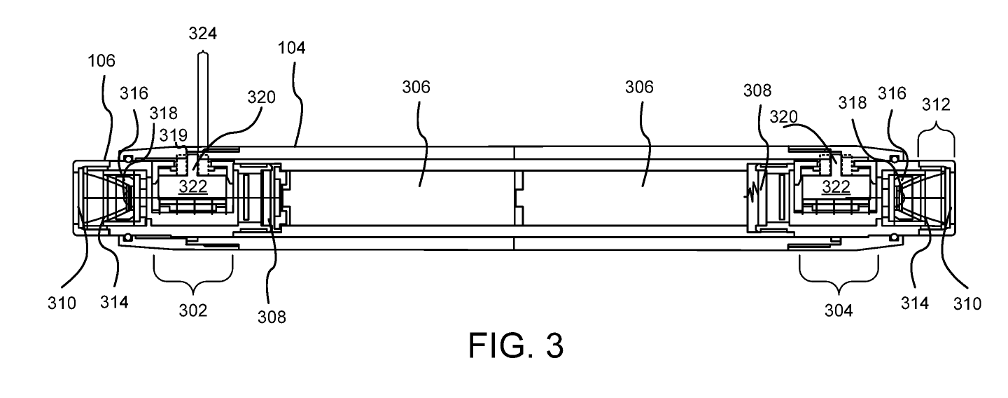

FIG. 3 is a side view cross-sectional diagram illustrating one embodiment of the flashlight 100 in accordance with embodiments of the disclosure. The flashlight 100, as described above, is formed having an inner chassis 106 that is configured to slideably engage the outer casing 104. The inner chassis 106 slides with reference to the outer casing 104 between one of at least 3 positions.

The inner chassis 106 is configured to support multiple components including, but not limited to, a first switch assembly 302, a second switch assembly 304, batteries 306, electrically conductive pathways 308, a lens 310 embedded in a lens head 312, a reflector 314, an LED dish 316, and an LED 318.

The first switch assembly 302 and the second switch assembly 304 are, in one embodiment, miniature slide switches. In one embodiment, the switch assemblies 302, 304 are single pole, double throw (SPDT) slide switches. The miniature switches may be formed with a switching lever 320 (or actuating arm) that extends outward from a body 322 (or housing) of the switch assembly 302, 304. The switching lever 320 is movable between at least 2 positions. In one embodiment, the switching lever 320 is movable between 3 positions as will be discussed in greater detail below.

In one embodiment, a shoulder 319 (or groove) formed in an interior surface of the outer casing 104 engages the switching lever 320 to actuate the first switching assembly 302. In a similar manner, a shoulder (or groove) may be formed in the interior surface of the outer casing 104 to engage the switching lever 320 of the second switching assembly 304. The switching levers 320 of both switching assemblies 302, 304 are configured with a substantially similar travel distance 324. As used herein, the term “travel distance” refers to a distance that the switching lever 320 travels between positions. In one embodiment, the travel distance 324 is in the range of between about 0.05 and 0.25 inches.

The conductive pathways 308 electrically couple the batteries 306 with the switch assemblies 302, 304 and the illumination sources (e.g., LED 318). The conductive pathways 308, in some embodiments may include printed circuit boards (“PCB”). Electrically conductive springs may be disposed between the batteries 306 and one of the printed circuit boards to ensure an electrically conductive contact between the batteries and the printed circuit board. The electrically conductive springs may be coupled with the printed circuit boards by any suitable method including, but not limited to, soldering. The inner chassis 106 provides a compressive force to maintain a position of the batteries 306 and keep the batteries 306 in electrical contact with the conductive pathways 308.

As described above, an illumination source may be disposed at each end of the inner chassis 106. In one embodiment, the components of each illumination source may include the LED 318. The LED 318 may be mounted to a PCB with the LED dish 316 extending outward from the PCB. A reflector 314 may be centered by the LED dish 316 and extend outward from the LED dish 316. These components function to focus or direct a light beam emitted by the LED 318. The LED head bezel 312 is attached to the inner chassis 106. For example, the LED head bezel 312 may include threads on an internal surface that engage threads on an external surface of the inner chassis 106. The lens 310 may be formed in the LED head bezel 312. In other embodiments, the lens 310 may be press fit into the LED head bezel 312.

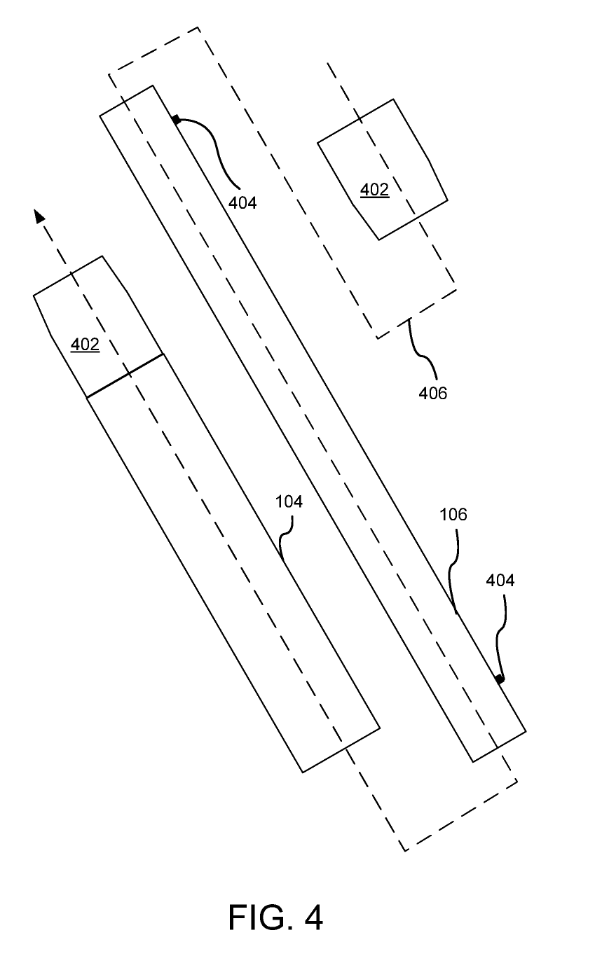

FIG. 4 is an exploded view block diagram illustrating one embodiment of the flashlight 100 in accordance with embodiments of the disclosure. The blocks illustrated in FIG. 4 are representative of the inner chassis 106, outer casing 104, and collars 402. Multiple components described above with reference to FIGS. 1-3 have been omitted here for clarity.

The inner chassis 106, as described above, is configured to slideably engage the outer casing 104. In one embodiment, collars 402 may be coupled to each end of the outer casing 104 to prevent the inner chassis 106 from sliding further than intended with reference to the outer casing 104. For example, stops 404 may be formed or otherwise attached to an outer surface of the inner chassis 106. The stops 404, in one embodiment are positioned and sized to engage a shoulder formed on an interior surface of the collar 402. Accordingly, the collars 402 limit the distance the inner chassis 106 may travel, from a default position, in one direction with reference to the outer casing 104. In one embodiment, the distance is substantially equivalent to the distance 324 described above with reference to FIG. 3.

In one embodiment, at least one collar is removably attachable to the outer casing 104. In another embodiment, both collars 402 are removable. The collars 402 may be formed with threads on an internal surface that are configured to engage with threads formed on an outer surface of the outer casing 104.

Dashed line 406 indicates one method of assembly of the flashlight in accordance with embodiments of the disclosure. As depicted, the inner chassis 106 may be inserted into the outer casing 104 that already has a collar 402 attached. Alternatively, one of the collars 402 may be integrally formed with the outer casing 104. The other collar 402 is then attached to the outer casing 104 so as to maintain the inner chassis 106 within the outer casing 106.

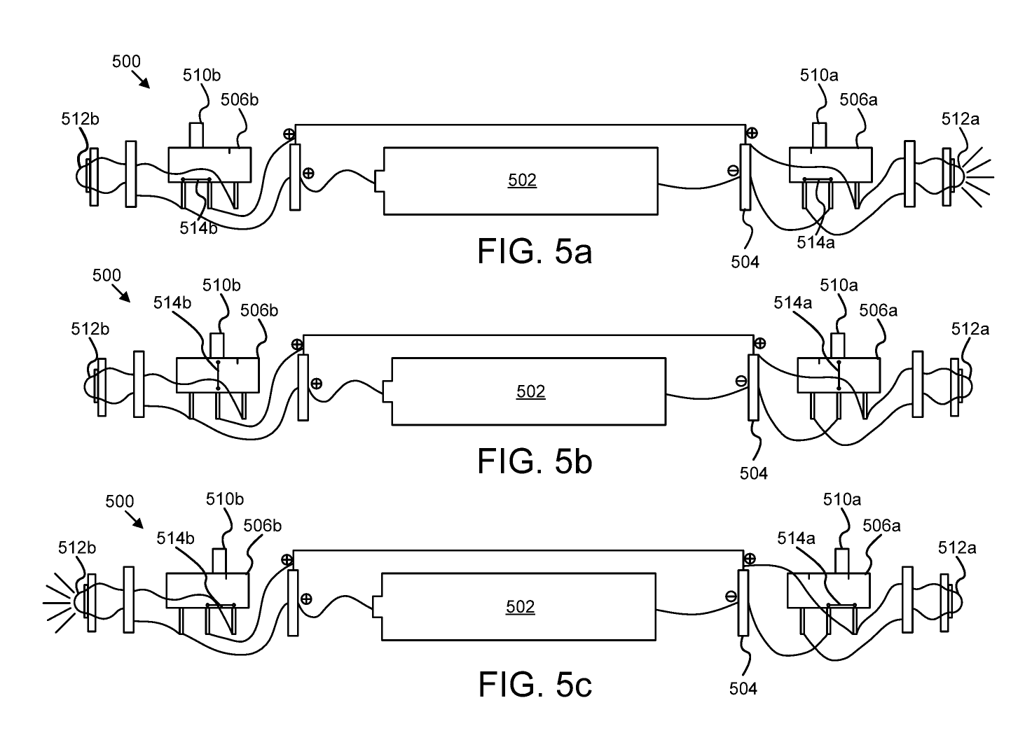

FIGS. 5A, 5B, and 5C are schematic block diagrams illustrating one embodiment of an electrical circuit of the flashlight in accordance with embodiments of the disclosure. As depicted, the electrical circuit 500 includes the components described above that function to energize the illumination sources. These components may include the battery 502 and the conductive connections (e.g., wires, traces, etc.) that electrically couple the battery 502 with the illumination sources. In one example, the conductive connections couple the battery 502 with PCBs 504, switches 506, and illumination sources 508.

In one embodiment, the switch levers 510a, 510b are movable between one of three positions. The switch levers 510a, 510b may be configured to move in unison with reference to the inner chassis. In other words, the outer casing is configured to simultaneously move both switch levers 510a, 510b in the same direction. In one embodiment, the outer casing moves the switch levers 510a, 510b away from the illumination source that will be energized. FIG. 5a illustrates one embodiment of the switch levers 510a, 510b in a position away from the illumination source 512a. As described above, the switches 506a, 506b are, in one embodiment, single pole, double throw, center off switches that are capable of switching between inputs/outputs on a single electrical circuit. The conductive connections may be attached, as depicted, to cause the switch to either: energize the illumination source, bypass current around the illumination source (short), or create an open circuit (disconnected circuit).

FIG. 5a is an illustration of a first switch position, where movable contacts 514a, 514b are positioned according to its corresponding switch lever 510a, 510b. The movable contacts 514a, 514b complete a circuit that energizes the illumination source 512a and deactivates the illumination source 512b. Similarly, FIG. 5c is an illustration of a second switch position where the movable contacts 514a, 514b complete a circuit that energizes the illumination source 512b and deactivates the illumination source 512a. Finally, FIG. 5b is an illustration of a third switch position where the movable contacts 514a, 514b create an open circuit where neither illumination source 512a, 512b is energized.

It is contemplated that other circuit wirings exist, other than the depicted circuit, that enable the functionality described above where one of the illumination sources is activated in response to the outer casing moving the switch levers. For example, in one embodiment, the outer casing may be configured with an internal surface that only activates one switch lever when moving in a first direction, and only moves the other switch lever when moving in an opposite, second direction. In another contemplated example, the outer casing may be configured to simultaneously activate switches that energize both illumination sources at the same time.

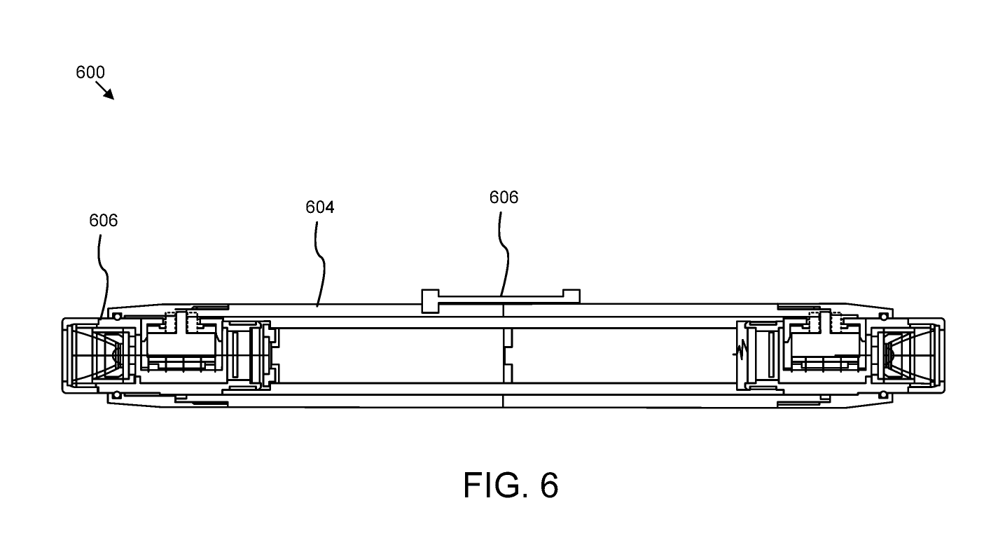

FIG. 6 is a side view cross-sectional diagram illustrating another embodiment of the flashlight 600 in accordance with embodiments of the disclosure. In the depicted embodiment, the flashlight 600 may include a locking mechanism 602 for fixing the position of the outer casing 604 with reference to the inner chassis 606. In one embodiment, the locking mechanism 602 may be a toggle lock with a portion that extends through the outer casing 604 into the inner chassis 606. A user may depress one end of toggle lock to engage the toggle lock. Depressing the opposing end will disengage the toggle lock and allow the outer casing 604 to move. In one embodiment, the locking mechanism 602 fixes the outer casing 604 in a position where neither illumination source is activated. Other locking mechanisms are contemplated, including, but not limited to, a toggle lock integrated into the pocket clip, and a twist lock mechanism. For example, it is contemplated that either the inner chassis or the outer casing includes a ridge that engages a corresponding keyway. The keyway may be shaped to limit rotation and lock the position of the outer casing with respect to the inner chassis to deactivate both illumination sources.

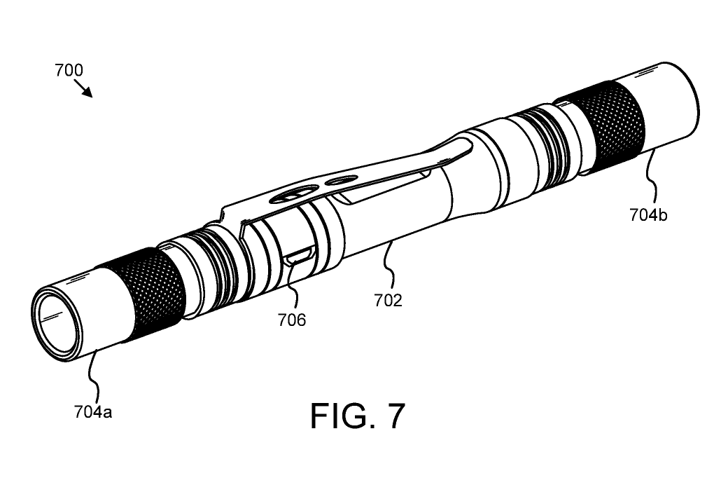

FIG. 7 is a perspective view diagram illustrating another embodiment of a dual headed flashlight 700, in accordance with embodiments of the disclosure. The flashlight 700, in the depicted embodiment, resembles the above described flashlight of FIGS. 1-6. However, in one embodiment, the flashlight 700 includes dual light sources that are energized independent of the main body or chassis 702. As described above, the light source is disposed within a cap or head 704 (referred to individually as head 704a or head 704b, and collectively as head 704). Each head 704a, 704b is slideable with reference to the body 702. In one embodiment, sliding the head 704a, 704b cause the light source disposed within the head 704a, 704b to be energized and emit light. In one embodiment, sliding the head 704a, 704b away from the body 702 energizes the light source. Alternatively, sliding the head 704a, 704b towards the body 702 energizes the light source. Also depicted is a charging port.

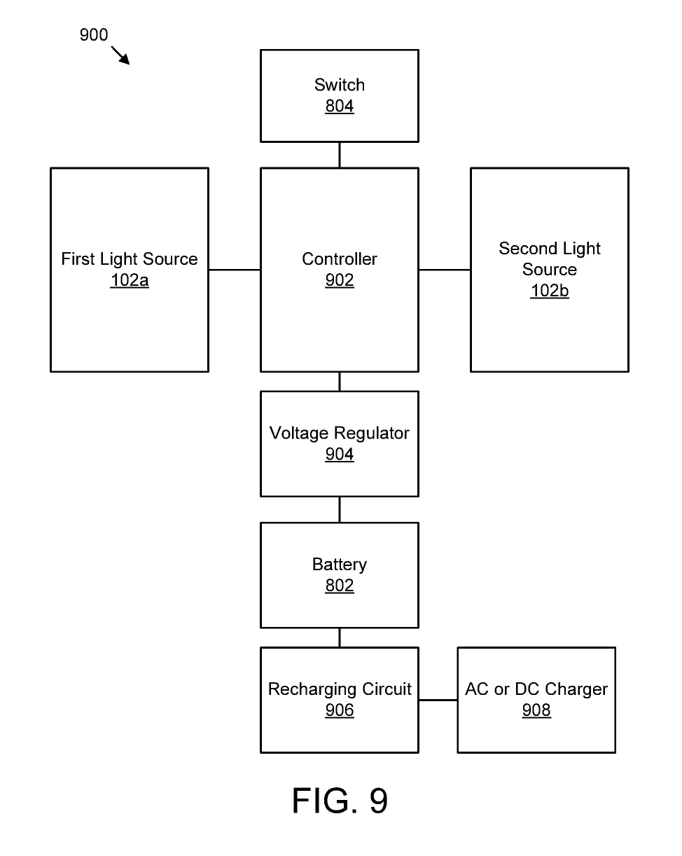

In one embodiment, the flashlight may include a charging port 706, which may be coupled to the charging circuit described below with reference to FIG. 9. In a particular embodiment, the charging port 706 may comprise a Universal Serial Bus (USB) port. In one embodiment, the charging port 706 may be a USB mini port. Alternatively, the charging port 706 may be a USB micro port. One of ordinary skill will recognize alternative charging port configurations, including custom configurations, which may be suitable for use with the described embodiments.

In the described embodiments, the light source heads 704a-b may be removable. In such an embodiment, the heads 704a-b may be modular and interchangeable. For example, head modules may include a head with incandescent bulbs, heads with various intensities or colors of LED light sources, a head with a UltraViolet (UV) light source, a head with an InfraRed (IR) light source, or heads with various colors and intensities of laser diode light sources. One of ordinary skill will recognize a variety of suitable light source head modules that may be suitable according to the present embodiments.

In an example, an automobile mechanic technician may use the dual head flashlight 700 to inspect and diagnose an engine problem. The technician may use a white LED light module to do a visual inspection. The technician may then inject a UV luminescent tracing fluid into the engine. The technician may swap the white LED head module for a UV head module, where the UV head is configured to emit light of a wavelength suitable for causing fluorescence of the tracing fluid. Using the UV head, the technician may identify any leaks in various engine components. The technician may then flip around the flashlight to use a laser diode light source on the second head to pinpoint the leak for a second technician to repair or replace. One of ordinary skill will recognize a variety of examples and scenarios where various light source heads may be useful. For example, hunting, camping, and survival situations.

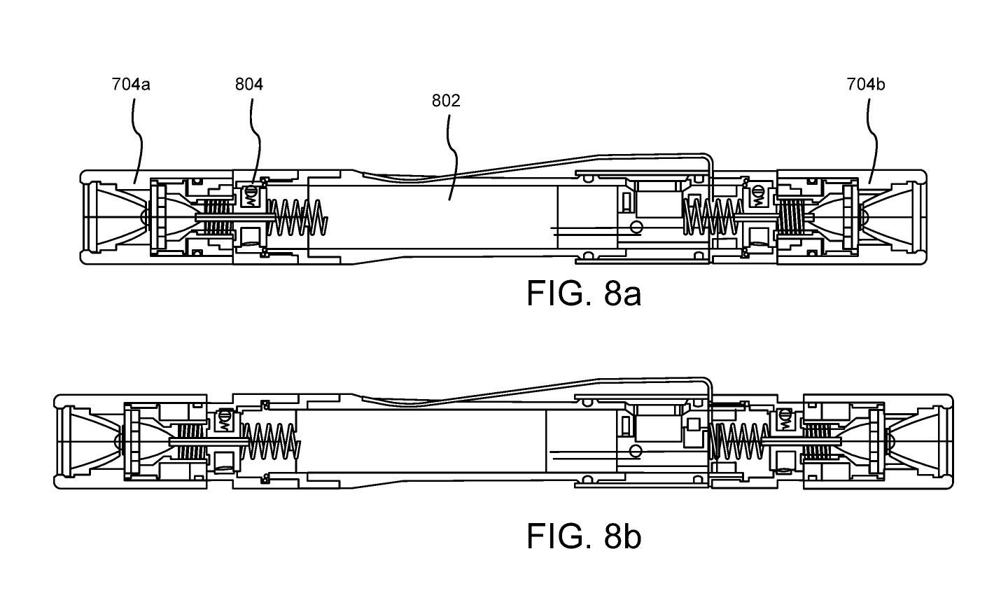

FIGS. 8A and 8B is a schematic block diagram illustrating a cross-sectional view of one embodiment of the flashlight 700. As depicted, the flashlight 700 includes a battery 802 for providing power to the light sources. Many of the components implemented in the depicted flashlight 700 are similar to those described above with reference to FIGS. 1-6, and for clarity will not be discussed again.

In one embodiment, the flashlight 700 includes a switch 804 configured to energize a power circuit when the head 704a is moved away from the body 702. One example of a switch 804 capable of use includes a biased ball detent as depicted. Once the head 704a moves, the ball is positioned to make contact with a conductive portion of the head 704a, 704b, which completes the power circuit and allows power to flow from battery 802 to the light source. In an “off” position, the ball detent contacts a non-conductive surface. FIG. 8a is a depiction of a dual headed flashlight 700 with both heads 704a, 704b in an off position. FIG. 8b, on the other hand, depicts a flashlight 700 with both heads 704a, 704b in an “on” position.

FIG. 9 is a schematic block diagram illustrating an embodiment of an electrical circuit 900 of one embodiment of the flashlight.

In one embodiment, the circuit 900 includes a controller 902. The controller 902 is configured for controlling the operation of the first light source 102a and the second light source 102b disposed on either end of the body 108 or chassis 702. The controller 902, in one embodiment, is an integrated circuit configured with one or more patterns for flashing and/or maintaining illumination of the different light source head modules.

As described above, the switch 804 is configured to receive user-input and communicate the user-input with the controller 902. For example, the switch 804 is useful for turning on and off the each light source 102a-b respectively. Additionally, the switch 804 may be used to cycle through any number of different light patterns. Alternatively, the switch 804 may be actuated to one of a plurality of positions. One of skill in the art will recognize the nearly limitless number of operating modes that may be programmed into the controller 902. One particularly useful mode of operation is to enable, and cause to flash, colored LEDs. For example, a red LED may be disposed in one of the first casings 704a or the second casing 704b and utilized as a warning light for a bicycle rider at night.

The controller 902 is powered, in one embodiment, by the battery 802 via the voltage regulator 904. The battery 802, in one embodiment, is powered by the recharging circuit 906 which is connected to an AC or DC charger 908. The AC or DC charger 908 is configured to either plug into a wall outlet, a cigarette lighter, or another power source. In a particular embodiment, the AC or DC charger 908 may comprise a USB charging circuit. The voltage regulator 904 is configured to receive power from the battery 802 and deliver it to the controller 902. In an alternative embodiment, the voltage regulator 904 also simultaneously supplies power to the controller 902 and the light sources 102a, b, etc.

Each operating mode, may be used to indicate, for example, an emergency. Alternatively, the operating mode may merely maintain any one of the light sources in an illuminated state, at one of a variety of selectable intensities.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A flashlight comprising:
an elongated chassis;
a first head having an illumination source, a first switch for energizing the first illumination source, and a first casing disposed around the first illumination source, the first head being slidably coupled to the elongated chassis, and configured to engage the first switch in a first position relative to the elongated chassis and to disengage the first switch in a second position relative to the elongated chassis; and
a second head having an illumination source, a second switch for energizing the second illumination source, and a second casing disposed around the second illumination source, the second head being slidably coupled to the elongated chassis, and configured to engage the second switch in a first position relative to the elongated chassis and to disengage the second switch in a second position relative to the elongated chassis.

2. The flashlight of claim 1, wherein at least one of the first head and the second head are removable from the elongated chassis.

3. The flashlight of claim 2, wherein at least one of the first head and the second head are interchangeable with one or more modular heads of an alternative configuration.

4. The flashlight of claim 1, wherein at least one of the first light source and the second light source comprise a Light Emitting Diode (LED) configured to emit light at an InfraRed (IR) wavelength.

5. The flashlight of claim 1, wherein at least one of the first light source and the second light source comprise a Light Emitting Diode (LED) configured to emit light at an UltraViolet (UV) wavelength.

6. The flashlight of claim 5, wherein the UV wavelength is a wavelength that causes a UV fluorescent tracer fluid to fluoresce.

7. The flashlight of claim 1, further comprising a power source coupled to the chassis and configured to supply power for energizing the first light source and the second light source.

8. The flashlight of claim 7, further comprising a charging circuit configured to receive power from an external power supply and to charge the power source.

9. The flashlight of claim 8, further comprising a charging port coupled to the charging circuit, the charging port configured to interface with the external power supply.

10. The flashlight of claim 9, wherein the charging port comprises a Universal Serial Bus (USB) port.

11. The flashlight of claim 7, further comprising a control circuit configured to control a characteristic of the power supplied by the power source to at least one of the first light source and the second light source.

12. The flashlight of claim 11, wherein at least one of the first switch and the second switch is configured to be set to a third position, wherein the third position is configured cause the control circuit to modify the power supplied from the power source to at least one of the first light source and the second light source.

13. A flashlight comprising:
an elongated inner chassis comprising a first illumination source, a first switch for energizing the first illumination source, a second illumination source, and a second switch for energizing the second illumination source; and
an elongated outer casing disposed around the elongated inner chassis and configured to slideably engage the elongated inner chassis, where the elongated outer casing is slideable between a first position that activates the first switch and a second position that activates the second switch.

14. The flashlight of claim 13, wherein at least one of the first head and the second head are removable from the elongated chassis.

15. The flashlight of claim 14, wherein at least one of the first head and the second head are interchangeable with one or more modular heads of an alternative configuration.

16. The flashlight of claim 13, wherein at least one of the first light source and the second light source comprise a Light Emitting Diode (LED) configured to emit light at an UltraViolet (UV) wavelength, wherein the UV wavelength is a wavelength that causes a UV fluorescent tracer fluid to fluoresce.

17. The flashlight of claim 13, further comprising a power source coupled to the chassis and configured to supply power for energizing the light source.

18. The flashlight of claim 17, further comprising a control circuit configured to control a characteristic of the power supplied by the power source to at least one of the first light source and the second light source.

19. The flashlight of claim 18, wherein at least one of the first switch and the second switch is configured to be set to a third position, wherein the third position is configured cause the control circuit to modify the power supplied from the power source to at least one of the first light source and the second light source.

20. A flashlight comprising:
an elongated chassis;
a first head having an illumination source, a first switch for energizing the first illumination source, and a first casing disposed around the first illumination source, the first head being slidably coupled to the elongated chassis, and configured to engage the first switch in a first position relative to the elongated chassis and to disengage the first switch in a second position relative to the elongated chassis;
a second head having an illumination source, a second switch for energizing the second illumination source, and a second casing disposed around the second illumination source, the second head being slidably coupled to the elongated chassis, and configured to engage the second switch in a first position relative to the elongated chassis and to disengage the second switch in a second position relative to the elongated chassis;
a power source coupled to the chassis and configured to supply power for energizing the first light source and the second light source;
a charging circuit configured to receive power from an external power supply and to charge the power source;
a Universal Serial Bus (USB) charging port coupled to the charging circuit, the charging port configured to interface with the external power supply; and
a control circuit configured to control a characteristic of the power supplied by the power source to at least one of the first light source and the second light source.
